(19) United States
(12) Patent Application Publication
(10) Pub. No.: US 2012/0235855 A1
(43) Pub. Date: Sep. 20, 2012

(54) ADVANCED LOW POWER PERSONNEL/VEHICLE DETECTING RADAR

(75) Inventors: JAMES LYNN KURTZ, Gainesville, FL (US); Charles Henry Overman, IV, Gainesville, FL (US); Philip Russell Carlson, Gainesville, FL (US)

(73) Assignee: UNIVERSITY OF FLORIDA RESEARCH FOUNDATION INC., GAINESVILLE, FL (US)

(21) Appl. No.: 13/423,989

(22) Filed: Mar. 19, 2012

Related U.S. Application Data
(60) Provisional application No. 61/454,106, filed on Mar. 18, 2011.

(51) Int. Cl. G01S 13/58; G01S 13/08

(52) U.S. Cl. 342/109; 342/128

(57) ABSTRACT

Embodiments of the subject invention relate to a method and apparatus for signal processing that reduces the average power used in a small size, frequency modulated continuous-wave (FMCW) radar. Such a small size, frequency modulated continuous-wave (FMCW) radar is referred to herein as a micro radar. Specific embodiments of the invention can be used to detect and/or track personnel, vehicle, and/or other targets.

### CROSS-REFERENCE TO RELATED APPLICATION

The present application claims the benefit of U.S. Provisional Application Ser. No. 61/454,106, filed Mar. 18, 2011, which is hereby incorporated by reference herein in its entirety, including any figures, tables, or drawings.

The subject invention was made with government support under U.S. Army Contract No. W15QKN-10-C-0031. The government has certain rights in this invention.

### BACKGROUND OF INVENTION

Small size radar sensors can be used for a number of military and commercial applications. In military applications, it may be desired to detect human, vehicle, or other targets when sensors are emplaced in unattended and possibly remote areas. Similar commercial security applications can use radar sensors to, for example, implement “smart fences” or home surveillance systems having one or more sensors. Many of these applications will benefit by the reduction of the average power required to operate the radar sensor, particularly when local power sources are utilized for the sensors.

Reducing the power requirements of a small size, frequency modulated continuous-wave (FMCW) radar, which can be referred to as a micro radar, typically relies on careful consideration of both the signal acquisition hardware and processing infrastructure as well as the operational schemes employed to conserve energy.

FIG. 1 shows a block diagram of the radio frequency (RF) components of a typical FMCW radar. In FIG. 1, a signal source is frequency modulated by a signal that is linearly increasing with time to generate a linear frequency modulated output signal centered at some desired radio frequency with some bandwidth, B. The signal source output may be amplified to increase the transmit power and the resulting frequency modulated signal is applied to the transmit antenna, Tx. The RF signal emanating from the transmit antenna may illuminate targets that are within the beamwidth of the antenna. Targets that are illuminated by the transmit antenna signal will reflect a portion of the transmit signal and the reflected signal, which is a time-delayed replica of the transmit signal, will be received by the radar receiver antenna, Rx. The signal from the receiver antenna may be amplified and the resulting signal applied to one input of a homodyne frequency mixer, or homodyne mixer, M1, in FIG. 1 at the point labeled R. A portion of the transmit signal is coupled off and may be amplified, after which the portion of the transmit signal is applied to the homodyne mixer at the point labeled T in FIG. 1. The output of the homodyne mixer, referred to as the intermediate frequency (IF), contains signals from which target range, target velocity, target size, and/or other target information may be derived. Other variants of the RF section of an FMCW radar are possible, as known to those skilled in the art.

There is a need in the art for a method and system for extracting target range, target velocity, target size and/or other target information from the output signal from the homodyne mixer using less power than currently available methods and systems.

### BRIEF SUMMARY

Embodiments of the subject invention relate to a method and apparatus for signal processing that reduces the average power used in a small size, frequency modulated continuous-wave (FMCW) radar. Such a small size, frequency modulated continuous-wave (FMCW) radar is referred to herein as a micro radar. Specific embodiments of the invention can be used to detect and/or track personnel, vehicle, and/or other targets.

Specific embodiments can utilize the FMCW radar system shown in FIG. 1 to produce a homodyne mixer output signal that carries target range information, target velocity information, target size information, and/or other target information, and digital signal processing to provide outputs relating to a target's range, a target's velocity, a target's size, and/or other target information.

FIG. 2 shows a block diagram of the homodyne mixer, M1, in an FMCW radar, such as that in FIG. 1, followed by a filter, F1, an analog-to-digital converter (ADC), and a digital signal processing unit. The two inputs to the homodyne mixer are the transmit signal (T) and the delayed receive signal (R); these signals are obtained from other radar sensor components, as in FIG. 1, for example. Signals at the output of the homodyne mixer contain information related to a target's range, speed, velocity, and size. The frequency of a signal at the mixer output is directly proportional to the delay or range to the target. The velocity of a moving target will cause the range to change as a function of time, which will cause a corresponding shift in the frequency of the received signal, commonly called the Doppler shift, which can also be measured. Different size targets will cause a portion of the transmit signal to be reflected back to the radar sensor, with larger or more reflective targets generally creating a larger amplitude reflected signal. A filter, such as F1 in FIG. 2, may be used to pass those signal frequencies corresponding to targets at certain ranges and to restrict the maximum frequency for further signal processing. The ADC in FIG. 2 converts the filtered analog signals to digital signals for processing in a digital signal processing unit.

The digital signal processing unit may be implemented in a number of different combinations of hardware, firmware, or software. In one embodiment, digital signal processor (DSP) hardware and firmware is employed to implement certain signal processing functions and create desired outputs. For example, in FIG. 2 a digital filter is used to provide additional filtering of the signals from the homodyne mixer output and the digital filter output is subsequently processed to create a range-Doppler map (RDM). The RDM signal processing may be implemented as a two-dimensional fast Fourier transform (FFT). The first FFT of samples from a modulation period can obtain range information, since range is proportional to frequency. A second FFT across some number of range-FFTs can obtain Doppler information, which can provide velocity information. After processing some number of samples of the filtered homodyne mixer output, the RDM contains the range and Doppler responses for measured targets in a two-dimensional array. The target signal amplitude, which is related to target size, may be represented as a third dimension of the RDM. The cells of the RDM array represent the radar target response for a particular processing dwell time, or the time to acquire the target samples. Further processing of the RDM cell values may be implemented in digital signal processing as shown in FIG. 2, and may include detection, tracking, target classification, and/or other signal processing functions. The results of these signal processing functions can be the outputs of the digital signal processing unit.

In an FMCW micro radar, signals corresponding to targets will be present at the homodyne mixer output and in the RDM cells when reflected target signals are captured by the radar antenna, provided the strength of the target signal relative to the noise is sufficiently strong; this is generally referred to as the target signal-to-noise ratio (SNR). Since the noise at the mixer output is usually wideband relative to the target signal bandwidth, target signal-to-noise ratio can be increased by filter F1 and subsequent filtering in the digital signal processing unit. If the RDM is created with a two-dimensional FFT the signal bandwidth after the first FFT (range FFT) is reduced from the IF bandwidth, and the signal bandwidth is reduced further after the second FFT (Doppler FFT). Therefore, there is progressively higher target SNR after the first and second FFT. Detection algorithms in the digital signal processing unit can be implemented to create one or more outputs that alerts to the possibility of a target based on the output at one or more of multiple stages of processing, namely, the IF output, the first FFT output, and the second FFT output, or can be used for subsequent processing to create other outputs. If the target strength is low, the detection algorithms may falsely indicate the presence of a target depending on the criteria for detection; such an output is referred to as a false alarm.

A challenge for many micro radar systems, such as systems using a FMCW radar as shown in FIG. 1, is to extend the operation time as much as possible for correctly alerting the presence of targets, without employing extensive duty cycling of the sensor, which can result in missing targets, and without an excessive number of false alarms. During large portions of the operation time of many such radar sensors, targets will not be present and the homodyne mixer output will be essentially noise, which is proportional to the radar receiver noise. In an embodiment, the radar sensor operates frequently enough to sense the presence of targets, but preferably not 100% of the time, since operating 100% of the time will result in unnecessarily high power usage. Power conservation in accordance with various embodiments of a radar sensor is achieved by an understanding of the operational scenario, such that the radar sensor interrogates the environment frequently enough to sense the target in the minimum target dwell time of the target, but not more often. In a specific embodiment, certain features of an FMCW micro radar allow an additional potential power savings by only operating selected portions of the radar sensor hardware and signal processing algorithms over select periods of time, sufficient to detect the presence of a target, without continued long-term operation of the hardware and processing algorithms upon either false targets or real targets requiring detection for only short periods of time. These features can be exploited by judicious staged operation of radar hardware, based on signal-to-noise ratio at different signal processing points, under the control of algorithms in the digital signal processing unit. In a specific embodiment, the subject techniques can be implemented with conventional digital signal processors and field programmable gate arrays (FPGAs) in appropriate combinations. Depending on the application, significant power savings may be realized using the subject techniques.

### BRIEF DESCRIPTION OF DRAWINGS

FIG. 1 shows a block diagram of radio frequency (RF) components of an FMCW radar in accordance with an embodiment of the subject invention.

FIG. 2 shows a block diagram of an embodiment of the subject invention having a FMCW homodyne mixer, filtering, and a digital signal processing unit.

FIG. 3 shows a block diagram of a system having three separate levels of potential pre-detection evaluation of target presence prior to engaging the system digital signal processor (DSP) for full detection, tracking, and/or classification.

FIG. 4 is a block diagram of an embodiment of the subject radar system showing the major component blocks.

### DETAILED DISCLOSURE

Embodiments of the subject invention relate to a method and apparatus incorporating signal processing that reduces the average power used in a small size, frequency modulated continuous-wave (FMCW) radar. Such a small size, FMCW radar is referred to herein as a micro radar. Specific embodiments of the invention can be used to detect and/or track personnel, vehicle, and/or targets.

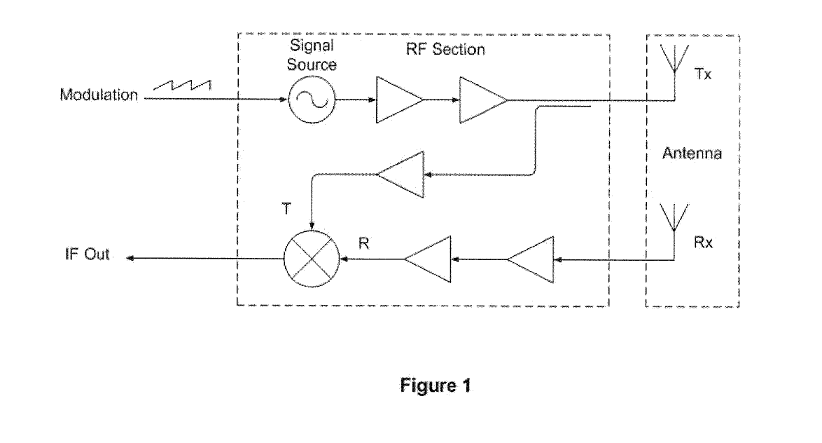

Specific embodiments can utilize the FMCW radar system shown in FIG. 1 to produce a homodyne mixer output signal that carries target range information, target velocity information, target size information, and/or other target information, and digital signal processing to provide outputs relating to a target's range, a target's velocity, a target's size, and/or other target information.

Specific embodiments can incorporate the use of programmable logic to more effectively distribute required computation to more efficient architectures. The use of programmable logic to more effectively distribute required computation to more efficient architectures can allow for significantly lower power early stage pre-detection mechanisms that reduce, and/or minimize, the unnecessary operation of full-power detection, tracking, and classification computation during times of target inactivity. In a specific embodiment, Field Programmable Gate Arrays (FPGAs) can be incorporated with an embodiment of the subject invention to provide capability for low power, highly parallel computation. FPGAs can be utilized for radar coprocessors to offload intensive, highly parallel processing from a higher level DSP, for example a higher level commercial DSP, to provide the speed necessary for specific applications. While some embodiments of the subject micro radar application do not utilize the FPGA and can meet system processing timelines, other embodiments utilize the FPGA to perform the highly parallel computation of the signal processing algorithms at considerable power savings. Further, the use of the FPGA to perform the highly parallel computation of the signal processing algorithms can allow for a reduction of the clock rate of complementary signal processors, such as a DSP performing certain functions. In a preferred embodiment, an FPGA radar coprocessor architecture is used that allows for improvement in signal processing efficiency as well as provide options to further lower power with pre-detection mechanisms, when environment target signal-to-noise permits. The FPGA may also provide timing and control signals for the micro radar system.

The initial processing stages in the FMCW micro radar signal processing utilize filtering, windowing, and a two-dimensional (2D) Fast Fourier Transform (FFT) process to focus target response energy in range versus velocity space while spreading the noise power across the same space. This effectively improves the observable signal-to-noise ratio and allows the desired detection probability at an acceptable false alarm rate. These initial processing functions typically require considerable computation and, therefore, many clock cycles from a general purpose DSP. In contrast, logic in an FPGA may be custom configured to provide the necessary computation in parallel, at a much slower clock rate with very little wasted clocking overhead. In a specific radar system, a 1.2 GHz DSP is not able to attain the necessary computation rate for the application. After the data acquisition, filtering, and 2D FFT processing operations were offloaded to an FPGA coprocessor, the radar system was able to attain the necessary computation rate for the application. In a specific embodiment, an FPGA coprocessor can provide the required functions at a clock rate of 100 MHz. An embodiment of the subject micro radar system can have a similar architecture and relationship to a system using a DSP alone, where the DSP alone requires several hundred megahertz to supply the necessary processing, and the embodiment utilizing an FPGA can supply the intensive parallel processing function up front at only a few megahertz and with significant power savings.

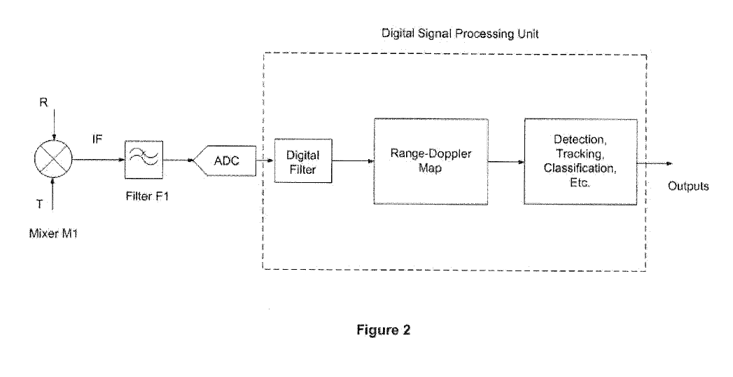

In a specific embodiment of the subject micro radar system, an FPGA coprocessor interfaces directly to the intermediate frequency (IF) sampling analog-to-digital converter (ADC) and controls data collection, filtering, and decimation. The FPGA then takes the two-dimensional (2D) Fast Fourier Transform (FFT) using a series of streaming FFT process blocks and direct memory access (DMA) transfers to double buffers implemented in external random access memory (RAM). Once computation of each Range-Doppler map is complete, data can be transferred from FPGA first input first output (FIFO) memory blocks to DSP memory via the external memory interface (EMIF) bus under the control of the DSP's DMA for detection, tracking, and/or classification. An embodiment of the invention that incorporates the FPGA processing architecture, along with a DSP, is illustrated in FIG. 2. FIG. 2 shows three separate levels of potential pre-detection evaluation of target presence prior to engaging the system DSP for full detection, tracking, and/or classification. The three levels determine the likelihood of a target at the intermediate frequency, at the results of range FFT processing, and at the full 2D FFT or RDM output, each level having potentially higher signal-to-noise ratio (SNR) if targets are present. The rate of engagement of the various stages impacts the total average power usage, which is a function of the selected detection probabilities and false alarm rates at each stage, as well as the expected rate of legitimate target presence requiring observation.

An important aspect of the range-Doppler processing is that it can be broken down into a series of signal-to-noise improvements as the processing is done to first discriminate by IF band SNR, then by range bin, and then by 2D range-velocity bin. Within the FPGA, this provides an option of shutting down processing of the later stages to save power when no target is present. This technique is analogous to target pre-detection at a lower signal-to-noise ratio; which for a determined probability of detection, dictates a higher false detection rate in that particular stage of pre-detection. The simplified process, however, will save considerable power. Once a pre-detection is indicated in an earlier, lower signal-to-noise ratio stage, the next level of processing can be employed to improve the signal-to-noise ratio for another determination at the cost of slightly more power consumption. The result of such a scheme is the need for operation of the more power hungry processing stages at a very low duty cycle and, subsequently, very low average power draw. In a specific embodiment, the FPGA can easily maintain a larger instantaneous dynamic range through the range Doppler map (RDM) computation process using block-floating processing in its FFT components, which can improve the dynamic range of target return power that may be simultaneously observed by the subject micro radar system over that of fixed-point DSP processing.

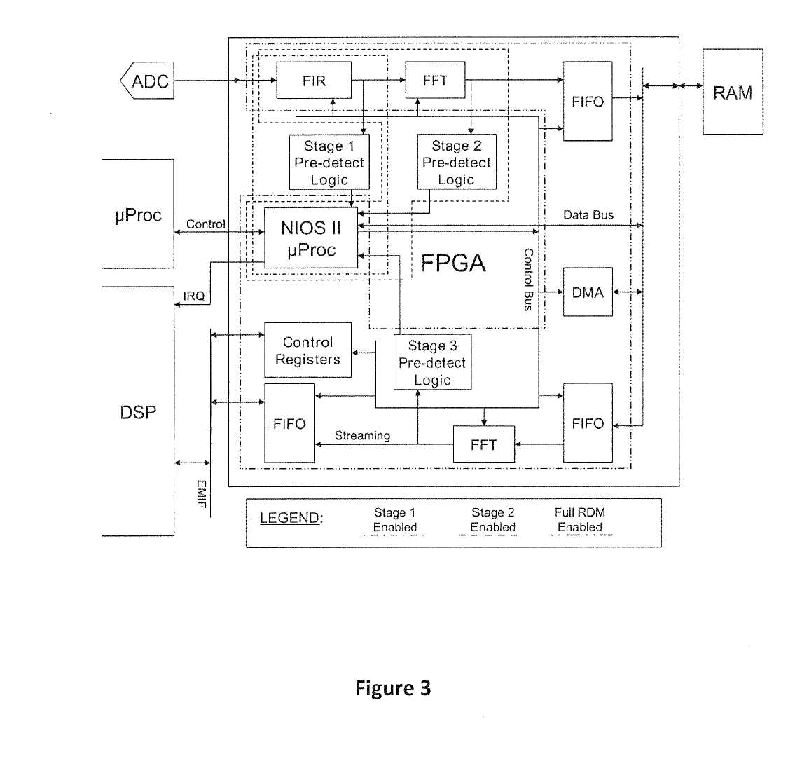

FIG. 3 shows three separate levels of potential pre-detection evaluation of target presence prior to engaging the system DSP for full detection, tracking, and classification. The three levels determine the likelihood of a target at the intermediate frequency, at the results of range FFT processing, and at the full 2D FFT or RDM output, each level having potentially higher SNR if targets are present. The rate of engagement of the various stages impacts the total average power usage, which is a function of the selected detection probabilities and false alarm rates at each stage, as well as the expected rate of legitimate target presence requiring observation.

### Example 1

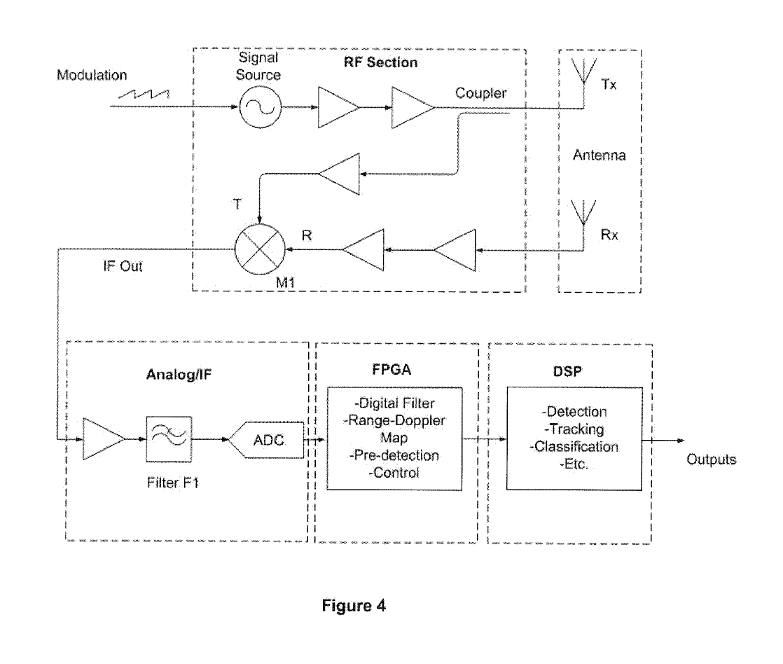

A block diagram for an embodiment of a FMCW micro radar system in accordance with the subject invention, showing the major blocks, i.e., the RF section, the Analog/IF section, the FPGA, and the DSP, is shown in FIG. 4. The FPGA block can incorporate circuitry, such as the circuitry shown in FIG. 3. The FMCW micro radar system utilizes pre-detection signal processing and the SNR and power estimates of the FPGA in pre-detection and full RDM operational modes. For this embodiment, it is desired to detect a vehicle target at a maximum range of at least 200 m and a human target at a maximum range of at least 50 m. Using references [1] for probability of detection versus SNR, a target response at the RDM output must exceed about 13 dB SNR in order to result in a detection probability (P_{d}) of at least 0.9 with false alarm probability (P_{fa}) of 10⁻⁶; other P_{d} and P_{fa} may be obtained from [1]. It is desired to exceed this P_{d} and reduce the P_{fa}. Assume, as an example, that from measured results the average measured SNR at the RDM output for the example vehicle target of radar cross-section (RCS)+10 dBsm exceeds 40 dB at close ranges (approximately 50 m) and measures 25 dB at 220 m. Using a minimum average RCS of a human target of −6 dBsm, the SNR would be reduced to greater than 24 dB at ranges of about 50 m, since it is a smaller target. This indicates the required SNR for the vehicle and human target detection can be achieved at the RDM output, with some margin. Therefore, from the test results, about 24 dB SNR is estimated for either human or vehicle targets at their maximum ranges of 50 and 200 m, respectively. With these SNR values, it is estimated that the practically achievable P_{d} is greater than 0.95 and P_{fa} is less than 10⁻¹⁰ [1] after detection in the RDM output (2D FFT processing), exceeding the minimum requirements.

Referring to FIG. 2, at the earlier stages of signal processing, either target will have a lower SNR than at the RDM output. The intermediate frequency SNR (stage 1) will theoretically be lower by an amount equal to 10 log(M N), where M and N are the number of range and Doppler bins, respectively, of the FFT. For this example M=128 and N=256, and the SNR reduction is about 45 dB. Reducing the SNR by this amount will result in target signals that are too noisy to provide reliable pre-detection estimates, without a large number of false alarms.

Therefore, the use of stage 1 pre-detection processing is not used in this example. At stage 2, after the range FFT, the theoretical SNR should be 10 log(N)=24 dB lower than at the RDM output. This means that a human target may only result in about 0 dB SNR in a single range FFT bin. The SNR is improved from that at the intermediate frequency due to the containment of the target response in a single range bin and the reduction of noise in that range bin, compared to the intermediate frequency bandwidth, although the SNR is still lower than at the RDM output. A single range bin SNR of about 0 dB corresponds to about 0.37 P_{d} and 10⁻¹ P_{fa} [1].

Additional improvements to SNR using the results of the first FFTs may be obtained by M out of N detection for each range bin for some number, N, of FFTs. Peebles [2, FIG. 9.8-1] indicates successful detection in 80 of 256 FFTs for any range bin should result in a P_{d} of 0.9 and a P_{fa} of 10⁻⁶, using M out of N detection. Therefore, the probability of detection at stage 2 can be nearly the same as at the output of stage 3 (RDM), but with higher probability of false alarm. Based on an approximate modulation frequency of 2.44 kHz, for this example, approximately 105 ms is required to acquire the 256 modulation periods. In this example the concept is to collect all 256 modulation periods, perform the 1D FFTs (range FFTs) and to save those results in RAM, as shown in FIG. 3. During stage 2 processing there are two substages, first data collection will collect the 256 modulation periods, which will require operating the RF, analog/IF, ancillary components and data buffering through the FIFO to RAM (DSP will be in a sleep mode) for about 105 ms. The remaining time required for stage 2 processing, is estimated to be approximately 3 ms, to determine if a target detection (or false alarm) occurs in any of the M out of N range bins and for power down of RF and analog components. The estimated false alarm time, T_{fa}, or time between false alarms, of stage two processing is 3.2 seconds (based on P_{fa}, of 10⁻⁶, bandwidth, Bᵣ, of 2.44 kHz and 128 frequency bins, N_{bins} (using T_{fa}=1/P_{fa}*Bᵣ*N_{bins})). This is the false alarm time for continuous operation. Periodic operation will result in a longer time between false alarms.

If the results of stage 2 processing indicate the presence of a target, the pre-detection processing will advance to stage 3. In stage 3, a second FFT will be taken across all range bins to create a range-Doppler map. A basic threshold detection algorithm can be used with the results of the stage 3 processing to confirm or reject the presence of the target. It is estimated that a P_{d} of 0.95 and a P_{fa} of 10° can be achieved at this stage, for the example. The time required for stage 3 processing is estimated to be approximately 108 ms (256 first FFTs have already been collected and processed in stage 2), the DSP remains in sleep mode. The estimated false alarm time of stage three processing is over 8 hours (30,500 S) (based on P_{fa}=10⁻¹⁰, B_{d}=10 Hz bandwidth, and map size 128×256=32,768 bins using (T_{fa}=1/P_{fa}*B_{d}*N_{bins})). This is the false alarm time for continuous operation. Periodic operation will result in a longer time between false alarms.

Finally, if the presence of the target is confirmed at stage 3, the DSP will be initiated. The full detection, tracking, and classification processing will commence. This DSP processing time will depend on the confirmation of a target, possibly using tracking association algorithms, and the length of the target time in the beamwidth. Target detection processing at this level is estimated to result in a P_{d} of 0.95 and a P_{fa} of 10⁻¹⁰, but additional processing in the tracking association stages can effectively reduce false alarm reporting further.

Estimates of the power requirements during the operation of each FPGA processing stage were determined by measurements of a representative FPGA and are presented in Table 1. Also shown in Table 1 is the time to perform stage 2 and stage 3 processing and the probability of false alarm, P_{fa}, and false alarm time, T_{fa}, resulting from the processing at those stages. The false alarm times in Table 1 are based on continuous operation with noise only, and represent the mean time for a false alarm. The effective false alarm in cycling operation is discussed in more detail below.

TABLE 1
FPGA power estimates processing times, P_{fa} and T_{fa}

| | Estimated | | | |
|---|---|---|---|---|
| | Power | | | |
| | Requirement | Time in stage | | |
| Operational Mode | (W) | (mS) | P_{fa} | T_{fa} (S) |
| Standby | 0.069 | NA | NA | NA |
| Stage 1 | Not used | NA | NA | NA |
| Stage 2 | 0.382 | 108 | 10⁻⁶ | 3.2 |
| Stage 3 (Full | <0.503 | 108 | <10⁻¹⁰ | 30,500 |
| RDM) | | | | |

### Power Consumption and Operational Power Savings Strategies

Referring to FIG. 3 and FIG. 4, the design goal is to maintain average power consumption of 1 W maximum. Other embodiments can have a higher or lower average power consumption. The radar antennas in the example micro radar are assumed to transmit and receive energy in a sector of approximately 90 degrees. Although the embodiments shown in FIG. 3 and FIG. 4 use a single transmit antenna and provide information in one dimension, such as how far away from the transmit antenna a target is and the speed at which the target is approaching, or retreating from, the transmit antenna, additional transmit antennas, and corresponding processing, can be utilized to provide information in two dimensions or three dimensions.

In a specific embodiment, the micro radar operates in one or more of the following modes: off, hibernate mode, sense-only mode, or ranging-classification mode. Once initiated (removed from “Off” mode), the micro radar can perform a self test then proceed into hibernate mode or other mode as described below, to await commands for other operational modes. Hibernate mode will be a minimal power consumption mode in which prior radar calibration can be retained. From the hibernate mode the radar can transition to either of the two other modes. For normal operation, the radar can be placed initially into sense-only mode. The micro radar can spend most of the operational time in the sense-only mode, in which it will periodically interrogate the environment to determine the presence of possible targets in the radar antenna beamwidth. In this mode, the system will consume relatively little power but can be sufficiently responsive so as to be able to initiate the ranging-classification mode. In the ranging-classification mode, more power will be consumed for range estimation, tracking, and classification of target types (personnel or vehicle). Preferably, ranging-classification mode should only occur for short durations when actual targets are in the area of interest. Therefore, the average power consumption can be primarily determined by the sense-only mode. Table 2 describes the state of each of the example micro radar component blocks, in terms of power consumption and duration in each mode. The major component blocks in Table 2 refer to FIG. 4, where ancillary includes all other power consumption not in the major blocks. It should be noted that this radar, with all blocks operated continuously consumes about 2.6 W of power, but the power consumption in staged operation is much less. A description of one embodiment of such staged operation is as follows. After turn on, hibernate mode can be the default mode until the radar is commanded into the sense-only mode or range-classification mode. The sense-only mode has sub-states shown in Table 2 (see FPGA discussion above). These sub-states are stage 2, stage 3, and sleep.

TABLE 2
Micro Radar modes: power consumption and duration^{1,2,3}

| MODE | RF | ANALOG/IF | FPGA | DSP | ANCILLARY | DURATION |
|---|---|---|---|---|---|---|
| HIBERNATE² | 20 MW | 0 | 69 MW | <0.01 MW | 14 MW | SEE TEXT |
| SENSE-ONLY | 1280 MW | 154 MW | 382 MW | <0.01 MW | 28 MW | 108 MS³ |
| (SNIFF-STAGE 2) | | | | | | |
| SENSE-ONLY | 20 MW | 0 | 503 MW | <0.01 MW | 28 MW | 108 MS |
| (SNIFF-STAGE 3) | | | | | | |
| SENSE-ONLY | 20 MW | 0 | 69 MW | <0.01 MW | 28 MW | SEE TEXT |
| (SLEEP) | | | | | | |
| RANGE- | 1280 MW | 154 MW | 503 MW | 422 MW | 28 MW | SEE TEXT |
| CLASSIFICATION | | | | | | |

Notes:
¹Power numbers in the table do not include regulator efficiency, but this is discussed in the text.
²Periodically, the Micro radar will perform calibration in the hibernate mode, with little impact to the average power consumption.
³A duration of 105 mS will be required to capture the data and an additional 3 ms to complete stage 2 processing and to allow for power down of RF and analog components.

The pre-detection technique described above uses algorithms in the FPGA in stage 2 pre-detection (data collection and 1D FFT), in concert with the RF and analog/IF components, to “sniff” the environment to determine if there are likely targets within the antenna beamwidth. In stage 3, the FPGA will complete a 2-D FFT, which creates an entire range-Doppler map and improves the detection signal-to-noise ratio. The DSP is powered down into a sleep configuration during the execution of the stages of the sense-only mode, and the system is consuming minimal power. The staged process in the FPGA results in different total power consumption at each stage. Estimates of the power consumption of Micro radar components for the example micro radar in each mode are summarized in Table 2, based on measurements and calculations for an actual system. Time estimates for each of the sense-only sub states are also shown in Table 2. If the Micro radar progresses directly from stage 2 to stage 3, the total time to sequentially process each of the sense-only sub-states is approximately 216 mS (108+108 mS). This may not always occur as discussed below.

Conservation of average power can be enhanced by judicious cycling of the primary components, according to Table 2, to perform the required operations. For a specific embodiment of a micro radar system, the following requirements are given: the minimum time a target will appear in the antenna beamwidth (5 seconds for a vehicle target) and the frequency with which any targets are expected to occur is assumed to be one target every 30 minutes. In order to be certain to detect a target with minimum duration of 5 seconds and to perform classification on that target, which may take up to 2 seconds, to the micro radar will sense the environment, with a period Ts, where the period is more frequent than every 3 seconds. Furthermore, for this embodiment of a micro radar system the typical target time should be a 9 second human target (the target time in the antenna beamwidth), but longer times are considered below.

Using a repetition period not longer than 3 seconds, the controller in the Micro radar can initiate the pre-detection algorithm by signaling the FPGA to make an estimate of possible targets in the antenna beamwidth. This can be done by turning on the waveform generation and other RF power components and initiating the FPGA pre-detection algorithms (sense-only mode). As noted above, pre-detection can begin with stage 2 processing in the FPGA (range-only FFT), in order to ensure sufficient SNR to sense the presence of the target without excessive false alarms. In this stage, the total power consumption is 1844/0.9=2048.9 mW, which is the sum of the component power consumption shown in Table 2 for this stage/mode (with a regulator efficiency of 90%).

In stage 2, 256 fast Fourier transforms (FFTs) of modulation periods can be performed to provide signal processing gain, as well as coarse range information about the targets in the antenna beamwidth. Also, in stage 2, after M out of N detection, the signal-to-noise ratio can be compared to some threshold. If the second stage pre-detection indicates the possible presence of targets, the third stage of the pre-detection algorithm can be initiated. In this third stage, a full 2-D fast Fourier transform can be performed, which can provide maximum signal-to-noise ratio. An efficient and simplified detection algorithm can be performed in the FPGA at this stage to determine the presence of targets. A regulator efficiency of 90% is assumed for the following discussion of power consumption of all components. In pre-detection stage 3, performing the 2D FFT and detection algorithm with other components shown in Table 2 consumes 551/0.9=612.2 mW. This last stage, if initiated, will also provide some velocity information on the targets, which may be used for confirmation of real versus false targets. Finally, in the last sub-state of the sense only mode, if a target is detected in stage 3, the DSP will then initiate ranging-classification stage with the component power consumption shown in Table 2 (2387/0.9)=2652.2 mW. The time to get through the pre-detection, sense-only mode sub-states 2 and 3 is approximately 216 milliseconds. During only a fraction of this time (sub-stage 2), the RF and analog/IF components are consuming power (<108 ms). The overall probability of correct detection increases, while the probability of false alarm decreases, in each successive stage of the pre-detection processing.

Based on the assumptions a real target lasting possibly 9 seconds will need to be detected, tracked and classified every 30 minutes, during which ranging-classification mode is initiated. During this time, the micro radar peak power consumption will be 2.652 W. The average power consumption from the infrequent processing of legitimate targets adds to the average power consumption for the sense-only stages, but only minimally due to the short target duration.

An estimate of average power should take into consideration the frequency of operation of each stage of the signal processing. A target or target/clutter environment that would cause all stages of processing to be initiated in sequence for every duty cycle period is unlikely. What is more likely is that the early stages will not frequently indicate the likelihood of a false target in the presence of noise only. To determine operation in this more likely scenario, the probabilities of false alarm and false alarm times in each stage can be considered. As discussed above, the average false alarm time for stage 2 was computed to be 3.2 seconds, while that for stage 3 was 30,500 seconds (8 hours). These average false alarm times are based on continuous operation. For periodic sampling of the noise in stage 2 and stage 3 processing, the effective duty cycle can be considered. We have estimated the effective false alarm time, T_{fa eff} for one occurrence of noise exceeding the threshold for stage 2 as follows:

Occurrences/S=(T_{stg2on}/Tₛ)(1 occurrence/3.2 S)

and

T_{fa eff2}=(1/(Occurrences/S))

Where, T_{stg2on}=0.108 S is the effective on time for stage 2, Tₛ is the sense period, for a resulting sense duty cycle of T_{stgf2on}/Tₛ. For a sense period of 2 seconds, the equivalent false alarm time for stage 2 is about 58 seconds. A similar calculation for stage 3 shows the equivalent false alarm time for stage 3 to be 564,814 seconds (156 hours), with T_{stg3on}=0.108 S and Tₛ=2 S. However, only when stage 2 causes stage 3 to operate, will there be false alarms in stage 3, which further increases the effective false alarm time in stage 3 to about 16.4×10⁶ seconds. The frequency of a stage 3 false alarm on noise is very low. These values are estimates and can be verified by testing and/or simulations to verify the effective false alarm times. Effective false alarm time for several duty cycles are calculated below. The estimates indicate it should be possible to achieve a false alarm time considerably longer than 8 hours. In specific embodiments of a micro radar system, additional features in the tracking association algorithm can further reduce the possibility of false alarms from noise or clutter. Such features include, but are not limited to, comparison of velocity of successive detects and a confirmation feature, which insures that more than one detect has been associated with a target track file before initiating the output of that track file. These features have been tested and shown to substantially reduce false targets from being output.

It is possible to compute the energy in Watt-seconds per day for operation of the micro radar in each stage of signal processing, including the ranging-classification stage, for an actual target every 30 minutes. Total average power is then obtained by dividing the total energy by the time in one day. Table 3 shows the resulting power consumption from such calculation, assuming the effective false alarm times of stage 2 and 3 for each duty cycle period is as shown in the table. In this calculation, since stage 2 will be initiated at multiples of the duty cycle period and stage 3 will be initiated at multiples of the stage 2 period, the calculated effective false alarm times have been rounded down to the closest multiple.

TABLE 3
Power consumption versus duty cycle,
false alarm time, and target time

PARAMETER

| | | | |
|---|---|---|---|
| DUTY CYCLE | 1 | 2 | 3 |
| PERIOD (S) | | | |
| STAGE 2, 1 FALSE | 29 | 58 | 87 |
| ALARM EVERY (S) | | | |
| STAGE 3, 1 FALSE | 8,189,803 | 1.64 × 106 | 2.46 × 106 |
| ALARM EVERY (S) | | | |
| ONE TARGET | 9 | 9 | 9 |
| EVERY 30 | | | |
| MINUTES OF | | | |
| DURATION (S): | | | |
| AVERAGE POWER | 0.352 | 0.248 | 0.213 |
| CONSUMPTION | | | |
| PER DAY (W) | | | |

Table 3 shows the average power consumption is 0.352 W or less for duty cycle period exceeding 1 second, the shortest expected duty cycle for the example micro radar. These calculations have assumed a 9 second target track time based on target time in the antenna beamwidth. In order to conserve power, the radar could stop tracking targets after a classification is made (approximately 2 S minimum) and lock out additional target tracks for some duration. Selection of the lock out and its duration could be made configurable. For cases where target tracking is more important to the user than power consumption, the user may elect to continue tracking the target.

Possible applications of small radars may require the tracking of a target for longer than 9 seconds. Calculations with a duty cycle period of 2 seconds and the duration of the target as 30 seconds and 60 seconds, respectively, the power has been calculated and shown in Table 4. All other parameters are as for the 2 second case of Table 3. The average power consumption only increases modestly for these longer duration targets.

TABLE 4
Average power versus target duration

| TARGET | AVERAGE |
|---|---|
| DURATION | POWER |
| (SECONDS) | (W) |
| 30 | 0.277 |
| 60 | 0.319 |

Aspects of the invention may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Specific hardware devices, programming languages, components, processes, protocols, and numerous details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention may be practiced without these specific details. Computer systems, servers, work stations, and other machines may be connected to one another across a communication medium including, for example, a network or networks.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In an embodiment, the present invention takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

The invention may be practiced in distributed-computing environments where tasks are performed by remote-processing devices that are linked through a communications network. In a distributed-computing environment, program modules may be located in both local and remote computer-storage media including memory storage devices. The computer-useable instructions form an interface to allow a computer to react according to a source of input. The instructions cooperate with other code segments to initiate a variety of tasks in response to data received in conjunction with the source of the received data.

The present invention may be practiced in a network environment such as a communications network. Such networks are widely used to connect various types of network elements, such as routers, servers, gateways, and so forth. Further, the invention may be practiced in a multi-network environment having various, connected public and/or private networks.

Communication between network elements may be wireless or wireline (wired). As will be appreciated by those skilled in the art, communication networks may take several different forms and may use several different communication protocols. And the present invention is not limited by the forms and communication protocols described herein.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

### REFERENCES

1. Hovanessian, S. A, Radar System Design and Analysis, Chapter 6 and FIG. 6-3, Artech House, Inc. Publisher, 1984,
2. Peebles, P. Z. Jr., Radar Principles, John Wiley and Sons, publisher, 1998.

What is claimed is:

1. A method for monitoring a region of interest, comprising:
(a) transmitting a transmit frequency modulated continuous-wave (FMCW) signal to a region of interest;
(b) receiving a reflected FMCW signal from the region of interest, wherein the reflected FMCW signal is a portion of the transmit FMCW signal reflected from a target;
(c) generating an intermediate frequency output signal from the reflected FMCW signal;
(d) applying an analog-to-digital converter to the intermediate frequency output signal to produce a digital output signal;
(e) performing a first one-dimensional (1D) fast Fourier transform (FFT) to the digital output signal over the modulation period to produce a first range-FFT;
(f) repeating (e) (n−1) times over a corresponding (n−1) modulation periods to produce (n−1) additional range-FFT's, wherein the first range-FFT and the (n−1) additional range-FFT's form a set of range-FFT's;
(g) performing a second 1D-FFT across the set of range-FFT's to produce a first Doppler-FFT; and
(h) repeating (g) (m−1) times to produce (m−1) additional Doppler-FFT's, wherein the first Doppler-FFT and the (m−1) additional Doppler-FFT's form a set of Doppler-FFT's.

2. The method according to claim 1, wherein the intermediate frequency output signal is produced by inputting the reflected FMCW signal into a homodyne frequency mixer and inputting a portion of the transmit FMCW signal into the homodyne frequency mixer, wherein an output of the homodyne frequency mixer is the intermediate frequency output signal.

3. The method according to claim 1, further comprising:
filtering the digital output signal prior to processing the digital output signal to create a range-Doppler map, wherein filtering the digital output signal removes portions of the digital output signal above a maximum frequency to produce a filtered digital output signal.

4. The method according to claim 1, wherein performing the first 1D-FFT provides range information.

5. The method according to claim 1, wherein performing the second 1D-FFT provides velocity information.

6. The method according to claim 1, further comprising:
producing a range-Doppler map from the set of range-FFT's and the set of Doppler-FFT's.

7. The method according to claim 6, wherein the range-Doppler map is a two-dimensional array.

8. The method according to claim 1, wherein a magnitude of the digital output signal is related to a size of a target the transmit FMCW signal reflected off of to produce the reflected FMCW signal.

9. The method according to claim 6, wherein a magnitude of the digital output signal is related to a size of a target the transmit FMCW signal reflected off of to produce the reflected FMCW signal, further comprising:
wherein the range-Doppler map is a three-dimensional array, wherein the magnitude of the digital output signal is the third dimension of the array.

10. The method according to claim 7, wherein the range-Doppler map had (m×n) cells, wherein the cells represent a response of the target over a target sample period.

11. The method according to claim 1, wherein (e) and (g) are accomplished via programmable logic.

12. The method according to claim 11, further comprising:
filtering the digital output signal prior to processing the digital output signal to create a range-Doppler map, wherein filtering the digital output signal removes portions of the digital output signal above a maximum frequency to produce a filtered digital output signal, wherein filtering the digital output signal is accomplished via programmable logic.

13. The method according to claim 11, wherein the programmable logic comprises at least one Field Programmable Gate Array (FPGA).

14. The method according to claim 12, wherein the programmable logic comprises at least one Field Programmable Gate Array (FPGA).

15. The method according to claim 3, further comprising:
processing the filtered digital output signal to determine a likelihood of a presence of a target.

16. The method according to claim 3, further comprising:
processing the set of range-FFT's to determine a likelihood of a presence of a target.

17. The method according to claim 15, further comprising:
if the likelihood of the presence of a target is above a threshold, processing the range-FFT's to determine a revised likelihood of the presence of the target.

18. The method according to claim 17, further comprising:
if the revised likelihood of the presence of the target is above a revised threshold, processing the range-Doppler map to determine a further revised likelihood of the presence of the target.

19. The method according to claim 16, further comprising:
if the likelihood of the presence of the target is above a threshold, processing the range-Doppler map to determine a revised likelihood of the presence of the target.

20. A method for monitoring a region of interest, comprising:
(a) transmitting a transmit frequency modulated continuous-wave (FMCW) signal to a region of interest;
(b) receiving a reflected FMCW signal from the region of interest, wherein the reflected FMCW signal is a portion of the transmit FMCW signal reflected from a target;
(c) generating an intermediate frequency output signal from the reflected FMCW signal;
(d) applying an analog-to-digital converter to the intermediate frequency output signal to produce a digital output signal;
(e) filtering the digital output signal to produce a filtered digital output signal, wherein filtering the digital output signal removes portions of the digital output signal above a maximum frequency; and
(f) processing the filtered digital output signal to determine a likelihood of a presence of a target.

21. The method according to claim 20, wherein if the likelihood of the presence of a target is above a threshold, further comprising:
(g) performing a first one-dimensional (1D) fast Fourier transform (FFT) to the digital output signal over the modulation period to produce a first range-FFT;
(h) repeating (g) (n−1) times over a corresponding (n−1) modulation periods to produce (n−1) additional range-FFT's, wherein the first range-FFT and the (n−1) additional range-FFT's form a set of range-FFT's; and
(i) processing the set of range-FFT's to determine a revised likelihood of the presence of the target.

22. The method according to claim 21, wherein if the revised likelihood of the presence of the target is above a revised threshold, further comprising:
(j) performing a second 1D-FFT across the set of range-FFT's to produce a first Doppler-FFT;
(k) repeating (j) (m−1) times to produce (m−1) additional Doppler-FFT's, wherein the first Doppler-FFT and the (m−1) additional Doppler-FFT's form a set of Doppler-FFT's; and
(l) processing the range-Doppler map to determine a further revised likelihood of the presence of the target.

23. A method for monitoring a region of interest, comprising:
(a) transmitting a transmit frequency modulated continuous-wave (FMCW) signal to a region of interest;
(b) receiving a reflected FMCW signal from the region of interest, wherein the reflected FMCW signal is a portion of the transmit FMCW signal reflected from a target;
(c) generating an intermediate frequency output signal from the reflected FMCW signal;
(d) applying an analog-to-digital converter to the intermediate frequency output signal to produce a digital output signal;
(e) filtering the digital output signal to produce a filtered digital output signal, wherein filtering the digital output signal removes portions of the digital output signal above a maximum frequency;
(f) performing a first one-dimensional (1D) fast Fourier transform (FFT) to the digital output signal over the modulation period to produce a first range-FFT;
(g) repeating (f) (n−1) times over a corresponding (n−1) modulation periods to produce (n−1) additional range-FFT's, wherein the first range-FFT and the (n−1) additional range-FFT's form a set of range-FFT's; and
(h) processing the set of range-FFT's to determine a likelihood of a presence of a target.

24. The method according to claim 23, wherein if the likelihood of the presence of the target is above a threshold, further comprising:
(i) performing a second 1D-FFT across the set of range-FFT's to produce a first Doppler-FFT;
(j) repeating (i) (m−1) times to produce (m−1) additional Doppler-FFT's, wherein the first Doppler-FFT and the (m−1) additional Doppler-FFT's form a set of Doppler-FFT's; and
(k) processing the range-Doppler map to determine a revised likelihood of the presence of the target.

25. An apparatus for monitoring a region of interest, comprising:
a transmitter, wherein the transmitter transmits a transmit frequency modulated continuous-wave (FMCW) signal to a region of interest;
a receiver, wherein the receiver receives a reflected FMCW signal from the region of interest, wherein the reflected FMCW signal is a portion of the transmit FMCW signal reflected from a target;
wherein the receiver generates an intermediate frequency output signal from the reflected FMCW signal;
an analog-to-digital converter, wherein the analog-to-digital converter produces a digital output signal from the intermediate frequency output signal to produce a digital output signal; and
a processor, wherein the processor performs a first range one-dimensional (1D) fast Fourier transform (FFT) to the digital output signal over the modulation period to produce a first range-FFT;
wherein the processor performs an additional range one-dimensional (1D) fast Fourier transform to the digital output signal (n−1) times over a corresponding (n−1) modulation periods to produce (n−1) additional range-FFT's, wherein the first range-FFT and the (n−1) additional range-FFT's form a set of range-FFT's;
wherein the processor performs a first Doppler 1D-FFT across the set of range-FFT's to produce a first Doppler-FFT;
wherein the processor performs an additional Doppler 1D-FFT (m−1) times to produce (m−1) additional Doppler-FFT's, wherein the first Doppler-FFT and the (m−1) additional Doppler-FFT's form a set of Doppler-FFT's.
